(19) United States
(12) Patent Application Publication
(10) Pub. No.: US 2007/0224886 A1
(43) Pub. Date: Sep. 27, 2007

(54) Electric Wiring

(76) Inventor: Giles Rodway, Calne (GB)

Correspondence Address: BARLEY SNYDER, LLC, 1000 WESTLAKES DRIVE, SUITE 275, BERWYN, PA, 19312, US

(21) Appl. No.: 11/689,666

(22) Filed: Mar. 22, 2007

(30) Foreign Application Priority Data
Mar. 24, 2006 (GB) 0605918.2

(51) Int. Cl. H01R 9/03

(52) U.S. Cl. 439/610

(57) ABSTRACT

An electric wire includes a conductive core, an inner sheath substantially surrounding the conductive core consisting of an extruded matrix of particulate material and binding material, and an outer sheath substantially surrounding the inner sheath.

### CROSS-REFERENCE TO RELATED APPLICATIONS

This application claims the benefit of the filing date under 35 U.S.C. §119(a)-(d) of United Kingdom Patent Application No. GB 0605918.2, filed Mar. 24, 2006.

### FIELD OF THE INVENTION

The invention relates to an electric wire comprising a conductive core, an inner sheath substantially surrounding the conductive core consisting of an extruded matrix of particulate material and binding material, and an outer sheath substantially surrounding the inner sheath.

### BACKGROUND

Electric wires may be used to conduct electrical signaling, for example, between electrical components and to supply power, for example, to connect a power supply to an electrical component. The wires generally comprise a conductive core encapsulated by one or more protective non-conductive sheaths. The conductive core can be made from a variety of conductive materials and may be formed from a single piece of conductive wire or a bunch of electrically conductive wires grouped or wound together. For example, in the case of electrical signaling wiring, the wires may comprise a conductive core consisting of a twisted pair of insulated electrical conductive material, such as copper, encapsulated inside a protective sheath.

There is significant demand in the automotive industry for high temperature electrical wiring for high temperature continuous use applications. Typically, in the case of routings close to exhaust manifolds, for example, electrical wiring may be required to be rated to operate at temperatures in excess of 150° C. (for 3000 h, for example, in the ISO 6722 automotive wire specification). In such applications, high temperature polymers, such as fluoropolymer, are used for the wire insulation materials, as these are among the few polymers capable of simultaneously meeting the mechanical, thermal, electrical, and chemical resistance requirements. The disadvantage of these high temperature polymers, such as ethylene tetrafluoroethylene (ETFE), fluorinated ethylene propylene (FEP), and polytetrafluoroethylene (PTFE), is that they are usually extremely expensive. For example, these high temperature polymers are often an order of magnitude more expensive per unit volume than the wire insulation materials for lower temperature applications, such as polyethylene (PE), polypropylene (PP), and polyvinyl chloride (PVC). Furthermore, these high temperature materials, although often over-specified for the applications for which they are used, are typically not suitable for blending with a high proportion of a lower cost “filler” material, to reduce the overall insulation cost per unit volume, as their filler acceptance is relatively poor.

For some applications, a reduction in the overall thickness of the wire insulation materials may be possible, thus reducing the amount of the wire insulation materials used and hence cost. There are limitations on this technique, however, as wire insulation materials which are too thin can be difficult to strip off for termination. Additionally, in certain applications, certain overall dimensions are required to ensure that the wire of a particular gauge fits into standard grommets or seals.

Given the above constraints, one method, which has been used to reduce the proportion of high temperature polymers in the wire insulation material, whilst still maintaining some of its beneficial properties, has been to extrude the high temperature polymer over a pre-extruded inner sheath of a low cost polymeric wire insulation material. In this way, this lower cost wire insulation material, which would not itself meet the full requirements of the specification at a particular temperature, is protected by an outer sheath of fluoropolymer. The most successful example of such a wire has been the ACW wire manufactured by Tyco Electronics, which is widely used by the European automotive industry in 150° C. rated applications since the late 1990s. This wire consists of a crosslinked polyethylene inner sheath of insulation, covered by a fluoropolymer (in this particular case, polyvinylidene fluoride (PVDF)) outer sheath.

Attempts to push such technologies to higher temperatures, principally 175° C. or 200° C. have, to date, been unsuccessful, because the polymeric inner sheath, upon ageing at the higher temperature, becomes embrittled. At, or before, the time corresponding to the required service life, the inner sheath embrittles to such an extent that it cracks into relatively large blocks of a stiff, embrittled material on flexing or bending. This, in turn, produces large stress concentrations in the outer sheath, which causes it to tear, and thus exposes the conductive core to the outside environment.

Examples of fire resistant wires comprising conductive cores surrounded by inner and outer insulating sheaths are disclosed in DE 19729395, DE 19728195, and EP 0076560. These fire resistant wires are designed to maintain circuit integrity after a fire and make use of powder compositions contained between the inner and outer sheaths to improve resistance to such high temperatures. However, the teachings of these documents do not relate to the use of powder compositions to form extruded sheaths.

### BRIEF SUMMARY

The invention provides an electric wire comprising a conductive core, an inner sheath substantially surrounding the conductive core consisting of an extruded matrix of particulate material and binding material, and an outer sheath substantially surrounding the inner sheath.

### BRIEF DESCRIPTION OF THE DRAWINGS

FIG. 1 is a cross-sectional view though a wire according to a first embodiment of the invention;

FIG. 2 is a cross-sectional view though a wire according to a second embodiment of the invention;

FIG. 3 is a cross sectional view though a wire according to a third embodiment of the invention; and

FIG. 4 is a cross-sectional view though a wire according to a fourth embodiment of the invention.

### DETAILED DESCRIPTION OF THE EMBODIMENT(S)

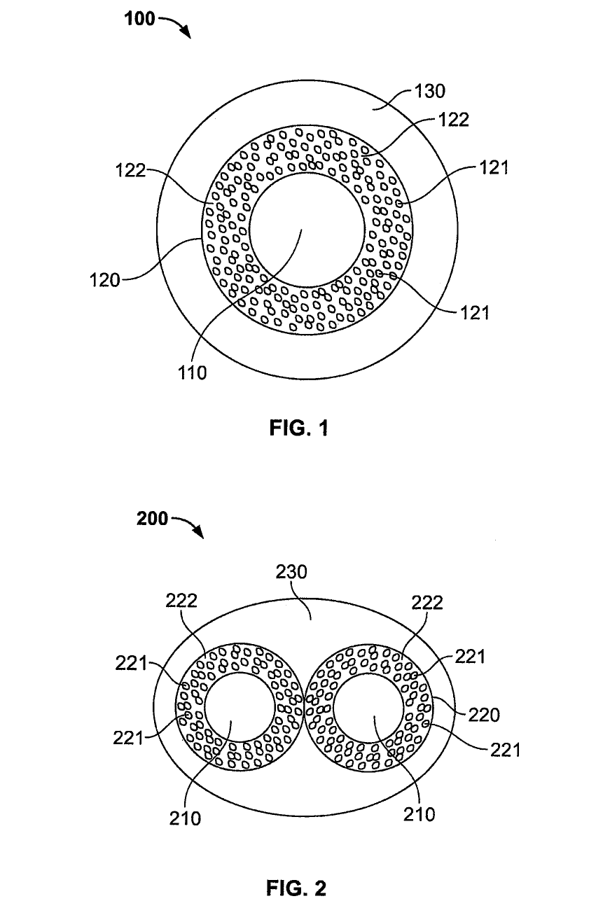

FIGS. 1-4 illustrate first, second, third, and fourth embodiments of a wire 100, 200, 300, 400 according to the invention. Similar reference numerals have been used to identify similar elements of each of the wires 100, 200, 300, 400 in each of the figures. The term “wire” as used herein should also be interpreted to include electric wires and electric cables, which are comparatively large electric wires. Additionally, the term “high temperature” as used herein refers to operating temperatures above 50° C. and more particularly within any range between 50° C. and 400° C. A high temperature automotive application would be, for example, an application having high continuous service temperatures of 3000 h at 200° C. The term “high temperature,” however, can refer to comparatively lower operating temperatures in the case of longer service life requirements. Further, although the embodiments of the invention described herein relate to high temperature electrical wiring for high temperature continuous use applications, such as those used in the automotive industry for routings near manifolds, catalytic converters, and diesel traps, all aspects and embodiments of the invention are not limited to such applications or operating conditions. Certain aspects and embodiments of the invention can be applied to other industries and applications and are not necessarily limited to use in such high temperature conditions.

FIG. 1 shows a first embodiment of a wire 100 according to the invention. The wire 100 comprises a conductive core 110 surrounded by an inner sheath 120. The inner sheath 120 is positioned immediately adjacent to the conductive core 110 and may be formed, for example, from extruded particulate material 121 and binding material 122. The inner sheath 120 is surrounded by an outer sheath 130. The outer sheath 130 is positioned immediately adjacent the inner sheath 120 and is formed to protect the inner sheath 120. The outer sheath 130 may be formed, for example, from an extruded polymer.

FIG. 2 shows a second embodiment of a wire 200 according to the invention. The wire 200 comprises at least two conductive cores 210. Each of the conductive cores 210 are surrounded by separate inner sheaths 220 positioned immediately adjacent thereto. The inner sheaths 320 are positioned to isolate the adjacent conductive cores 310 from one another. Each of the inner sheaths 220 may be separately extruded and may be formed, for example, from extruded particulate material 221 and binding material 222. The inner sheaths 220 are held together by a single outer sheath 230 that surrounds the inner sheaths 220. The outer sheath 230 is positioned immediately adjacent the inner sheaths 220 and is formed to protect the inner sheaths 220. The outer sheath 230 may be formed, for example, from an extruded polymer.

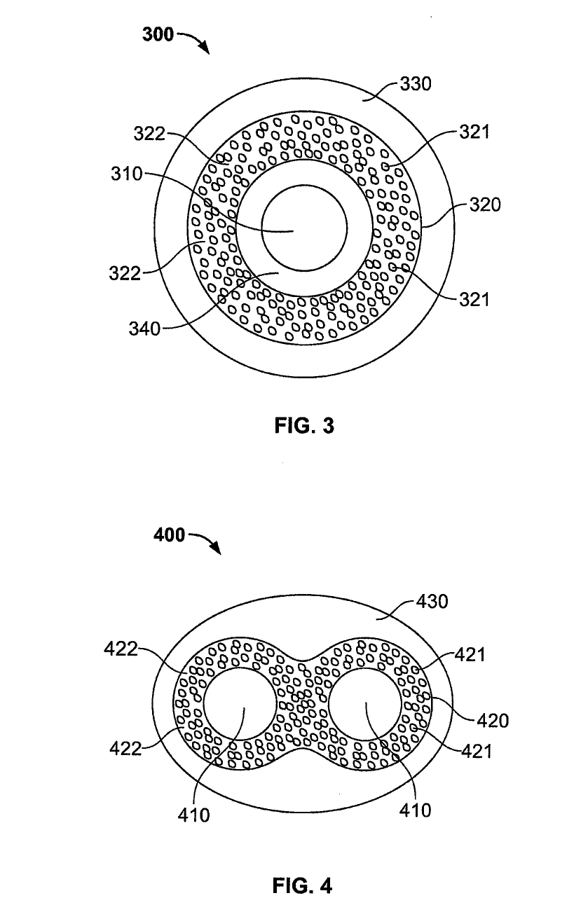

FIG. 3 shows a third embodiment of a wire 300 according to the invention. The wire 300 comprises a conductive core 310 surrounded by intermediate sheath 340. The intermediate sheath 330 may be formed, for example, from an extruded polymer. An inner sheath 320 surrounds the intermediate sheath 340. The inner sheath 320 may be formed, for example, from extruded particulate material 321 and binding material 322. The inner sheath 320 is surrounded by an outer sheath 330. The outer sheath 330 is positioned immediately adjacent the inner sheath 320 and is formed to protect the inner sheath 320. The outer sheath 330 may be formed, for example, from an extruded polymer.

FIG. 4 shows a fourth embodiment of a wire 400 according to the invention. The wire 400 comprises at least two conductive cores 410. The conductive cores 410 are surrounded by a single inner sheath 420 positioned immediately adjacent thereto. The inner sheath 420 is formed to isolate the adjacent conductive cores 410 from one another. The inner sheath 420 may be formed, for example, from extruded particulate material 421 and binding material 422. The inner sheath 420 is surrounded by an outer sheath 430. The outer sheath 430 is positioned immediately adjacent the inner sheath 420 and is formed to protect the inner sheath 420. The outer sheath 430 may be formed, for example, from an extruded polymer.

In the first, second, third, and fourth embodiments of the wire 100, 200, 300, 400 according to the invention, the inner sheath 120, 220, 320, 420 may comprise, for example, at least 65% by weight of the particulate material 121, 221, 321, 421 and more particularly at least 65%-99% by weight of the particulate material 121, 221, 321, 421 prior to or after extrusion. The particulate material 121, 221, 321, 421 may be, for example, magnesium hydroxide (Mg(OH)₂), talc, calcium carbonate, zinc sulphide, titanium dioxide, aluminum trihydrate, silica, alumina, antimony trioxide, other inorganic or organic filler materials, blends of one or more of such materials, or a refractory material. The balance of the formulation of the inner sheath 120, 220, 320, 420 consisting of the binding material 122, 222, 322, 422 may comprise, a “binding” polymer and process aids, such as zinc stearate, added in quantities as necessary to assist compounding (the production of a compound by mixing ingredients). The “binding” polymer may be, for example, polypropylene (PP), ethylene-vinyl acetate (EVA), polyethylene (PE), polyvinyl chloride (PVC) or other relatively low cost polymer, co-polymer, ter-polymer, or polymer blend. The relative composition of the particulate material 121, 221, 321, 421 to the binding material 122, 222, 322, 422 may also be by volume rather than by weight, particularly for other types of particulate and binding material compositions.

In the first, second, third, and fourth embodiments of the wire 100, 200, 300, 400 according to the invention, the outer sheath 130, 230, 330, 430 may comprise, for example, a polymer or fluoropolymer, such as ethylene tetrafluoroethylene (ETFE), fluorinated ethylene propylene (FEP), perfluoroalkoxy polymer resin (PFA), tetrafluoroethylene perfluoromethylvinylether (MFA), ethylene chlorotrifluoroethylene (ECTFE), or polyvinylidene fluoride (PVDF) or a fluoroelastomer, as well as similar stabilizers, colors, cross-linking promoters and other additives that are well known in commercially available single wall wires for high temperature automotive applications. The outer sheath 130, 230, 330, 430 may also be comprised of other materials that are able to withstand high temperatures, such as polyetheretherketone (PEEK) or ULTEM or lower temperature polymer formulations, such as polyester, thermoplastic elastomers (TPEs), polypropylene (PP), or crosslinked polyethylene. These materials are particularly beneficial when other properties, such as circuit integrity after burning the wire, reduced stiffness, or reduced cost compared to single layer constructions, are required.

In general terms, the inner sheath 120, 220, 320, 420 is formed such that it is “friable”. In other words, the inner sheath 120, 220, 320, 420 easily breaks up into small particles or a powder when subject to a mechanical stress, such as flexing, pressure, or impact, but holds together during manufacturing operations or in static applications. This combination of properties can be achieved, for example, by putting a certain range of extremely high inorganic particulate material 121, 221, 321, 421 (typically greater than 70% by volume or weight) into a matrix of polymeric binding material 122, 222, 322, 422. The outer sheath 130, 230, 330, 430 is made from a more conventional polymer formulation to provide the wire 100, 200, 300, 400 with temperature resistance, mechanical integrity, chemical resistance, and electrical insulation in normal operating conditions. Further, the materials for the inner and outer sheaths 120, 220, 320, 420, 130, 230, 330, 430 may be chosen to contribute to the desired characteristics of the wire 100, 200, 300, 400, such as hot compression resistance, and/or flame retardance.

Because the composition of the inner sheath 120, 220, 320, 420 is deliberately designed to be friable, it would typically be full of cracks at all times in service, and in certain compositions, may possibly fall off the wire 100, 200, 300, 400 after a fire. Depending on the material used for the inner sheath 120, 220, 320, 420, the inner sheath 120, 220, 320, 420 might also form a stable char layer, possibly together with the outer sheath 130, 230, 330, 430, or the particulate material 121, 221, 321, 421 might sinter together to provide sufficient mechanical strength to maintain the electrical integrity of the wire 100, 200, 300, 400. The outer sheath 130, 230, 330, 430 therefore provides electrical and mechanical properties in service, but may not necessarily be expected to hold the conductive core 110, 210, 310, 410 together after a fire.

Certain embodiments, however, may be useful in fire-resistant wire applications. Currently, in such applications, refractory tape, which is wrapped around the conductive core, forms the inner sheath and provides circuit integrity under fire conditions. In certain embodiments of the invention described herein, the particulate material 121, 221, 321, 421 of the inner sheath 120, 220, 320, 420 may be a refractory material. Such an arrangement may still provide the circuit integrity which is required in fire-resistant applications. Furthermore, any microcracks, which are formed in such an inner sheath 120, 220, 320, 420, may be reduced by a sintering process, which would occur under exposure to fire. Thus, even if the outer sheath 130, 230, 330, 430 were burnt away, some circuit resistance may still be provided by such a sintered inner sheath 120, 220, 320, 420. The outer sheath 130, 230, 330, 430 may form a char upon burning.

To form the wire 100, 200, 300, 400, both the inner and outer sheaths 120, 220, 320, 420, 130, 230, 330, 430 are extruded onto the conductive core 110, 210, 310, 410. This can be done by appropriately adapted standard extrusion processes used for making wires. The wires 100, 200, 300, 400 according to the invention can also be made by appropriately adapted pressure, tube, tandem, or co-extrusion processes. The particulate material 121, 221, 321, 421 and the binding material 122, 222, 322, 422 may be compounded, and then the resulting compound pelletized in a separate step prior to extrusion. During extrusion, the compound pellets can then be fed into an extruder. In the extrusion step, the pelletized compound is re-melted and extruded around the conductive core 110, 210, 310, 410 to form the inner sheath 120, 220, 320, 420. It is apparent that the particulates have a degree of high temperature resistance to remain as the particulate material 121, 221, 321, 421. Specifically, the particulate material 121, 221, 321, 421 has a melting point which is higher than the pelletization/extrusion temperature used to form the inner sheath 120, 220, 320, 420. The binding material 122, 222, 322, 422 has a melting point which is lower than the pelletization/extrusion temperature used to form the inner sheath 120, 220, 320, 420.

The inner and outer sheaths 120, 220, 320, 420, 130, 230, 330, 430 in the wires 100, 200, 300, 400 can be of various thicknesses. For example, it has been possible for the inner sheath 120, 220, 320, 420 to have a thickness of 0.25-0.35 mm and the outer sheath 130, 230, 330, 430 to have a thickness of 1.1-0.13 mm using 85% wt magnesium hydroxide with mesh size 325. The particulate material 121, 221, 321, 421 can have various sizes, shapes and distributions throughout the inner sheath 120, 220, 320, 420.

The wires 100, 200, 300, 400 according to the first, second, third, and fourth embodiments described herein have potential advantages over existing products in several applications. For example, because the high-cost fluoropolymer sheaths of the prior art are partially replaced by the much lower cost inner sheaths 120, 220, 320, 420, the wires 100, 200, 300, 400 allow dimensional and functional requirements to be met at much lower cost than with traditional constructions. Furthermore, problems associated with conventional dual wall constructions made from low cost polymeric inner sheaths, such as crack propagation from the inner sheath to the outer sheath after thermal ageing, are avoided by the powdery/particulate nature of the inner sheaths 120, 220, 320, 420.

Additionally, the wires 100, 200, 300, 400 according to the first, second, third, and fourth embodiments described herein fulfill the dimensional and specification requirements of high temperature automotive wiring applications at minimum cost, by using a minimum amount of fluoropolymer insulation while retaining the ability to extrude both the inner and outer sheaths 120, 220, 320, 420, 130, 230, 330, 430. This is achieved because the inner sheath 120, 220, 320, 420 has a high concentration of the particulate material 121, 221, 321, 421 compared to the binding material 122, 222, 322, 422. The inner sheath 120, 220, 320, 420 therefore is designed to have no structural function other than to be an extrudable filler and to be “benign” when it cracks to the structure of the outer sheath 130, 230, 330, 430. The inner sheath 120, 220, 320, 420 is therefore unlike conventional low cost polymer materials which typically break into large, glassy chunks after ageing, which can rupture the outer sheath 130, 230, 330, 430 on bending. Further, if just a powder were used as the material of the inner sheath, the product would not be extrudable, and hence could not be manufactured economically. The wires 100, 200, 300, 400 can therefore provide cheaper automotive wiring while still meeting the high temperature specification requirements.

In the present invention, the failure mode described in the background section of the present specification, is avoided by making the inner sheath 120, 220, 320, 420 friable such that it breaks up on bending after ageing into a small scale particulate or powdery form. The inner sheath 120, 220, 320, 420, which is significantly weaker than a polymeric sheath at all times in the ageing cycle, does not lead to cracking of the outer sheath 130, 230, 330, 430, because the way the material of the inner sheath 120, 220, 320, 420 breaks up avoids the high stress concentrations associated with large cracks. The outer sheath 130, 230, 330, 430 is thus able to contain the powder and to elongate in a uniform way to cover it on bending. By the present technique, rated temperatures for the inner and outer sheaths 120, 220, 320, 420, 130, 230, 330, 430 equivalent to the rated temperature of the fluoropolymer when aged as a single wall sheath are achievable (for example, 200° C. in the case of crosslinked ethylene tetrafluoroethylene (ETFE) insulation).

The foregoing illustrates some of the possibilities for practicing the invention. Many other embodiments are possible within the scope and spirit of the invention. For example, one or more elements of the embodiments of the invention described herein may be combined with one or more elements of other embodiments of the invention described herein, whether or not specifically mentioned or claimed in that combination. Additionally, the wires 100, 200, 300, 400 may contain more than just the inner and outer layers 120, 220, 320, 420, 130, 230, 330, 430. It is, therefore, intended that the foregoing description be regarded as illustrative rather than limiting, and that the scope of the invention is given by the appended claims together with their full range of equivalents.

What is claimed is:

1. An electric wire, comprising:
a conductive core;
an inner sheath substantially surrounding the conductive core, the inner sheath consisting of an extruded matrix of particulate material and binding material; and
an outer sheath substantially surrounding the inner sheath.

2. The electric wire of claim 1, wherein the inner sheath is at least 65% by weight or volume of the particulate material.

3. The electric wire of claim 2, wherein the inner sheath is between 80%-95% by weight or volume of the particulate material.

4. The electric wire of claim 1, wherein the particulate material comprises magnesium hydroxide.

5. The electric wire of claim 1, wherein the particulate material comprises a refractory material.

6. The electric wire of claim 1, wherein the binding material is a polymer or polymer blend.

7. The electric wire of claim 1, wherein the inner sheath is friable.

8. The electric wire of claim 1, wherein the outer sheath consists of a temperature resistant material.

9. The electric wire of claim 1, wherein the outer sheath consists of a polymer of fluoropolymer.

10. The electric wire of claim 1, wherein the inner and outer sheaths are immediately adjacent to one another.

11. The electric wire of claim 1, wherein the electric wire has at least two conductive cores.

12. The electric wire of claim 1, further comprising an intermediate sheath arranged between the inner sheath and the conductive core.

13. The electric wire of claim 1, wherein the inner sheath has a thickness of 0.25-0.35 mm.

14. The electric wire of claim 1, wherein the inner sheath sinters at a temperature above 50° C. to maintain the electrical integrity of the electric wire.

15. The electric wire of claim 1, wherein the outer sheath chars at a temperature above 50° C. to provide sufficient mechanical strength to maintain the electrical integrity of the electric wire.

16. The electric wire of claim 1, wherein the inner sheath chars at a temperature above 50° C. to provide sufficient mechanical strength to maintain the electrical integrity of the electric wire.
